(19) United States
(12) Patent Application Publication
(10) Pub. No.: US 2013/0205303 A1
(43) Pub. Date: Aug. 8, 2013

(54) Efficient Checking of Pairwise Reachability in Multi-Threaded Programs

(71) Applicant: NEC Laboratories America, Inc., Princeton, NJ (US)

(72) Inventor: Malay Ganai, Plainsboro, NJ (US)

(73) Assignee: NEC Laboratories America, Inc., Princeton, NJ (US)

(21) Appl. No.: 13/687,384

(22) Filed: Nov. 28, 2012

Related U.S. Application Data
(60) Provisional application No. 61/564,356, filed on Nov. 29, 2011.

(51) Int. Cl. G06F 9/52

(52) U.S. Cl. CPC G06F 9/524
USPC 718/106

(57) ABSTRACT

Disclosed is a simple but yet effective strategy to check pairwise reachability in an online analysis under a general locking scheme where locks may be acquired in recursive, non-nested, or nested manner. Under data abstraction, such an approach guarantees true positives and negatives for two-threaded system. For more than two threaded, it guarantees either true positive or true negative (but not both). It uses time stamped lock/unlock events to identify and avoid redundant and inconsistent sequence. Importantly, the approach is incremental and reduce amortized cost of checking multiple pairwise reachability problems. The worst case complexity is quadratic in the length of the history; in practice, however, the running cost is linear in the length of the history. Such an approach improves the accuracy of the race prediction for general locking style that includes recursive, nesting/non-nesting, and thereby improving the overall runtime verification

### TECHNICAL FIELD

This disclosure relates generally to the field of computer software and in particular to a method for checking pairwise reachability in an online analysis of concurrent computer programs having two or more threads.

### BACKGROUND

Pairwise reachability problems—checking if a pair of threads can simultaneously be at a given pair of locations—often arise during dynamic concurrency testing of multi-threaded programs. For example, checking atomicity violations, data races, mismatched wait/notify, mismatched semaphore wait/post etc require solving multiple pairwise reachability problems.

Given their importance to the analysis and/or verification of concurrent computer programs, methods and techniques that improve pairwise reachability analysis would represent an advance in the art.

### SUMMARY

An advance in the art is made according to an aspect of the present disclosure directed to an efficient method to check pairwise reachability in an online analysis of concurrent programs having two or more threads synchronizing with re-entrant/non-nested/nested locks, wait/notify etc. The method employs a forward traversal using time stamped history of lock/unlock events (TLH), and various simplifications to significantly reduce search cost.

Advantageously, in the absence of non-synchronization data, the method according to the present disclosure guarantees true positives or true negatives (but not both) for general concurrent programs, and guarantees true positives and negatives for a two-threaded program.

Importantly, the approach is incremental, and the amortized cost of multiple checks (with overlapping histories) is reduced significantly. The worst case complexity of the approach is quadratic in the length of the TLHs; in practice however, the running cost is linear in the length of TLHs.

### BRIEF DESCRIPTION OF THE DRAWING

A more complete understanding of the present disclosure may be realized by reference to the accompanying drawings in which:

FIG. 1 is a listing of events of threads tₐ and t_{b} according to an aspect of the present disclosure;

FIG. 2 depicts the checking of pairwise reachability of (a₁₀, b₁₀) according to an aspect of the present disclosure;

FIG. 3 depicts the checking of pairwise reachability of (a₁₀, b₁₁), (a₁₁, b₁₁), and (a₁₁, b₁₁) incrementally according to an aspect of the present disclosure;

FIG. 4 depicts Procedure 1—Check_reach: which checks pairwise reachability an according to an aspect of the present disclosure;

FIG. 5 depicts Procedure 2—do_search: which is a recursive search from a start pair according to the present disclosure;

FIG. 6 depicts Procedure 3—do_search: continuation of FIG. 5, according to aspects of the present disclosure;

FIG. 7 depicts TABLE 1 that shows an exemplary run of Check_reach to check pairwise reachability of (a₁₀, b₁₀) according to an aspect of the present disclosure;

FIG. 8 depicts TABLE 2 that shows short descriptions of the benchmarks used in experiments according to an aspect of the present disclosure;

FIG. 9 depicts TABLE 3 that shows pairwise reachability according to an aspect of the present disclosure;

FIG. 10 depicts TABLE 4 that shows an analysis of the check_reach procedure according to an aspect of the present disclosure;

FIG. 11 depicts a representative flow diagram that shows an overview of the steps associated with a method according to an aspect of the present disclosure;

FIGS. 12(a) and 12(b) depict a detailed Procedure check_reach((aₒ, bₒ), (aₘ, bₙ)//assuming that (a₀<aₘ) or (b₀<bₘ) according to aspects of the present disclosure;

FIG. 13 is a schematic block diagram of a representative computer system with which a method according to the present disclosure may be practiced.

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently-known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

In addition, it will be appreciated by those skilled in art that any flow charts, flow diagrams, state transition diagrams, pseudocode, and the like represent various processes which may be substantially represented in computer readable medium and so executed by a computer or processor, whether or not such computer or processor is explicitly shown.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Finally, and unless otherwise explicitly specified herein, the drawings are not drawn to scale.

Thus, for example, it will be appreciated by those skilled in the art that the diagrams herein represent conceptual views of illustrative structures embodying the principles of the disclosure.

### Introduction

By way of some additional background, we note that many online analysis techniques use lockset-based analysis happen-before analysis based on vector clocks or a combination of both. We note further that as used herein online analysis is carried out during program execution—as opposed of offline analysis which is carried out after program termination. Due in part to the low overhead of these techniques, they are generally preferred to symbolic-based offline analysis. Although symbolic analysis can provide better precision and coverage, its high overhead oftentimes hinders its practicability for online analysis.

Lockset-based analysis tracks a set of locks (i.e., locksets) currently held by each thread. Pairwise reachability between the current thread locations is inferred when locksets at those locations are disjoint, which can be checked in O(|L|) (|L|≡number of locks). In general, this technique may give false positive (i.e., spurious reachability) result as it fails to take the causal ordering of synchronization events.

Happens-before analysis is often used in conjunction with lockset-analysis to improve accuracy. It uses vector clocks to order inter-thread causal events such as lock/unlock, wait/notify etc. Pairwise reachability is inferred when the vector clocks at the pair locations are in-comparable, i.e., not ordered by causal events, which can be checked in O(|T|) (|T|≡number of threads). For checking data races, the vector clock of the current memory access is compared against that of the last recorded memory access (at the same location and at least one access is write). Happen-before analysis, however, can miss a data race due to enforcing an inter-thread order between unlock/lock events.

In practice, a hybrid approach is oftentimes used, where ordering between unlock/lock is not enforced, thereby detecting more races (some maybe spurious) than otherwise pure happens-before analysis. To avoid spuriousness, order between unlock/lock is relaxed as long as read-after-write order is not violated. However, these techniques in general can give a false positive as it is based on lockset based analysis that ignores the history of lock/unlock events.

In previous works, lock histories have been used to improve the accuracy of lockset-based analysis, albeit, at a higher cost. For nested locks, (i.e., a lock that is first acquired is released last), pairwise un-reachability can be reasoned in O(m+n) where m and n are the number of lock/unblock events in the history of the respective threads. For non-nested locks, it was shown that pairwise unreachability can be reasoned in O(|T|²·|M|²) in the worst case where |T| is the number of threads, and |M| is the maximum length of the synchronization events (i.e., lock/unlock, wait/notify, etc.). It involves building a universal causality graph (UCG) using various synchronization events and checking if it is acyclic. For two-threaded program, it was shown that acyclicity is both a necessary and sufficient condition for reasoning pair-wise reachability under data abstraction. However, for more than two threads, acyclicity was shown to be only the necessary but not the sufficient condition, i.e., a false positive can occur.

This approach was proposed mainly for offline analysis, and is not suitable for online analysis which demands high accuracy, high performance and low overhead. For checking pairwise reachability, we find that UCG analysis does not satisfy our requirements for at least the following reasons:
Partial ordering between lock/unlock events induced by other synchronization events can be easily inferred using vector clocks that are typically used in an online analysis. UCG analysis, however, derive this information indirectly, adding to the analysis cost.
UCG analysis is not incremental, i.e., the graph as built is not reusable for multiple pairwise reachability checks that arise frequently during online analysis.
For more than two threads, UCG analysis may result in false positives.

According to an aspect of the present disclosure, disclosed herein is a simple but yet effective method to check pairwise reachability in an online analysis of general concurrent programs with two or more threads, synchronizing with re-entrant/non-nested/nested locks, wait/notify etc. The approach is based on a forward traversal using history of time stamped lock/unlock events (TLH), and employing various simplification steps to reduce the search cost.

In absence of non-synchronization data, the method advantageously guarantees either true positives or true negatives (but not both) for general concurrent programs; and guarantees true positives and negatives for two-threaded program. Importantly, the approach is incremental, and the amortized cost of checking multiple pairwise reachability problems (with overlapping histories) is reduced significantly. The worst case complexity of the approach is quadratic in the length of the TLHs; in practice however, the running cost is linear in the length of TLHs.

The method according to the present disclosure has been implemented as a COP (Causal Online Predictor) module in BEST tool framework. BEST is a x86 binary-based concurrency testing framework using offline symbolic analysis module to predict concurrency errors. In our experimentation, we evaluate and compare non-incremental and incremental implementations in details, and demonstrate the efficacy of our proposed approach.

Preliminaries

A multi-threaded program consists of a set of concurrently executing threads T, each thread with a unique identifier t. The threads communicate with shared objects, some of which are used for synchronization such as locks and signals. A trace of a program π is a total ordered sequence of observed events corresponding to various thread operations on shared objects. Each event e of the sequence, i.e., e∈π is carried out at a unique thread location loc(e). These events include the following:
write(t,x)/read(t,x): memory write/read by t on object x
lock(t,l)/unlock(t,l): lock acquire/release by t on a lock object l
wait(t,s)/notify(t,s): wait/notify by t on a signal object s
fork(t,t′)/thread_start(t′): t forks a thread t′
join(t,t′)/thread_end(t′): t waits until t′ ends

We use next(e) to denote the next event of e in a thread program order. If c=loc(e) and c′=loc(e′), then we use (e,e′) and (c,c′) to refer to the same location pair.

If threads t,t′ are at locations c,c′ respectively, we say the pair (c,c′) is pairwise reachable, iff the threads can be at those locations simultaneously.

A data race is said to occur when two threads accesses a shared memory location, at least one of the accesses is a write, and those access locations are pairwise reachable.

Happens-Before.

Given a trace π of a program, and events e,e′∈π, we say e happens-before e′, i.e., e [symbol] e′, if e is observed before e′ in the trace. Notably, the event e completes before e′. We say e must happen-before e′, denoted as e [symbol] e′ if e [symbol] e′ holds and one of the following holds:
thread order: e,e′ belong to the same thread, denoted as e [symbol] ₚₒ e′
notify/wait: e=notify(t,s) and e′=wait(t′,s), t≠t′
fork/thread_start: e=fork(t,t′) and e′=thread_start(t′)
thread_end/join: e′=join(t′,t) and e=thread_end(t)
∃e₁,e₂∈π. (e [symbol] e₁ [symbol] e₂ [symbol] e′)

Observe, we don't consider [symbol] ordering due to unlock(t′,l)/lock(t,l). Note that the last condition holds by transitivity. Such transitivity conditions for must-happens-before relation can easily be maintained by vector clocks. A vector clock of a thread, denoted as VC(t), records the clocks of all threads. Whenever non-locking synchronization occurs, vector clocks are updated. Each event is time stamped with a vector clock. Vector clock implementations are known in the art.

We identify the events wait, thread_start, and join as blocking events; and the events notify, fork, and thread_end as the respective unblocking events. For correct synchronization, a thread has to be in a blocked state by initiating one of the blocking events e′ before the matching unblocking event e unblocks it, and the unblocking event “completes” before the blocking event. We use [symbol] _{ub} (⊂ [symbol] ) to denote the must-happens-before relation between the matching unblocking (e) event and blocking e′ event, i.e., e [symbol] _{ub} e′.

The relations [symbol] , [symbol] _{ub} can be checked simply by comparing the time stamps (i.e., the vector clocks) of the events. For a concurrent program with T threads, such a check would cost O(|T|) comparison. We use e [symbol] e′ to denote that e,e′ are in-comparable, i.e., e [symbol] e′ [symbol] e′ [symbol] e. This occurs if and only if the events e,e′ do not have unblocking/blocking synchronization in between. We map must-happen-before relation between events to thread locations naturally, i.e., e [symbol] e′ iff loc(e) [symbol] loc(next(e′)).

A necessary condition for (e,e′) to be pairwise reachable is e [symbol] e′.

Locking.

In nested locking, all locks follow a simple rule: a lock that is first acquired is released the last. A locking scheme that does not follow the nesting rule is often termed as non-nested locking. In our discussion, we will consider the general form of locking, i.e., non-nesting scheme. For re-entrant locks where lock can be acquired by a thread multiple times without releasing, we record the first lock and last unlock operations for each re-entrant lock.

A lockset is a set of locks held by a thread at location c, denoted as LS(c). If c=loc(e), we use LS(c) and LS(e) interchangeably. Given e′=next(e), we compute a lockset LS(e′) recursively as follows:

$$\begin{matrix}LS ( {e}^{′} ) = LS ( e ) ⋃ \{ l \} if e = lock ( t , l ) \\ = LS ( e ) \backslash \{ l \} if e = unlock ( t , l ) \\ = LS ( e ) otherwise\end{matrix} \qquad ( 1 )$$

If e=thread_start(t), then LS(e)=Ø.

Similar to lockset, we define a lockvector as a vector of lock acquisition count, i.e., the number of times each lock is acquired by a thread at location c, denoted as LV(c). We compute a lockvector LV(e′) recursively as follows:

LV(e′)[l]=LV(e)[l]+1 if e=lock(t,l)

∀l≠l′LV(e′)[l′]=LV(e)[l′] if e=lock(t,l)

∀l.LV(e′)[l]=LV(e)[l] otherwise (2)

If e=thread_start(t), then ∀l.LV(e)[l]=0. One can easily determine if a lock was acquired between the two events e [symbol] ₚₒ e′ by checking the predicate (LV(e′)[l]>LV(e)[l]).

A necessary condition for (e,e′) to be pairwise reachable is that LS(e)∩LS(e′)=Ø.

Time-stamped Lock History (TLH):

Given a thread a, a time-stamped lock history denoted as H^{a}=a₀ . . . aₘ, is a thread order sequence of observed lock/unlock events (referred as history events) each with a time stamp (maintained using vector clocks), and aₘ is the last such event before the current location, i.e., loc(next(aₘ)). Such time stamps can be used to check must-happen-before ordering between history events of two different threads in O(|T|) time.

We say a total-ordered sequence of lock events consistent iff (a) for every consecutive locking events there is an unlocking event on the same lock object in between by a thread doing the first lock, and (b) each lock event follows the must-happens-before ordering.

If (a,b) is pairwise reachable, and there exists a consistent sequence of lock events such that events a′,b′ are adjacent in the sequence, then we say (a′,b′) is also pairwise reachable.

Basic Aspects

Problem Statement.

Let the time-stamp lock histories of two threads tₐ,t_{b} be H^{a}=a₀ . . . aₘ and H^{b}=b₀ . . . bₙ, respectively, and the current thread locations be ├ₐ (=next(aₘ)) and ├_{b} (=next(bₘ), respectively. The goal is to show that (├ₐ,├_{b}) is pairwise reachable along a consistent sequence starting from (a₀,b₀). We will assume ├ₐ [symbol] ├_{b} and LS(├ₐ)∩LS(├_{b})=Ø; otherwise, a happens-before analysis or lockset analysis would detect (├ₐ,├_{b}) pairwise unreachable.

### Example

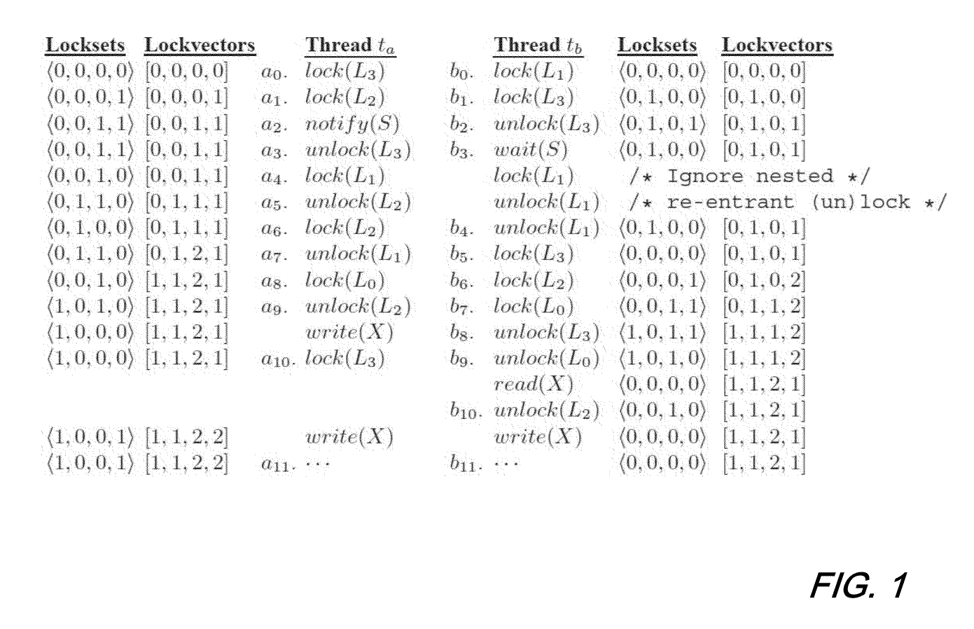

We use the following example to illustrate our approach. Two threads tₐ and t_{b}, with various events at locations aᵢ,bⱼ respectively, are shown in FIG. 1. The lock L₁ is a re-entrant lock in thread t_{b}. We record the outer lock/unlock events at b₀/b₄, and ignore the nested locks/unlocks. The wait event at b₃ is synchronized with the notify event at a₂ by signal S, i.e., notify(t_{b},s) [symbol] wait(tₐ,s). We also use aᵢ,bⱼ to denote the corresponding events. For example, the thread location a₀ denotes the lock(tₐ,L₃) event.

We show the locksets at each thread location as the tuple of Boolean values [symbol] LH₀, . . . , LH₃ [symbol] where LHᵢ=1 iff lock Lᵢ is held by the thread. For example, lockset [symbol] 0,0,1,1 [symbol] at location a₃ denotes L₂,L₃ are held by thread tₐ. Similarly, we show the lockvectors at each thread location [LA_{O}, . . . , LA₃], where LAᵢ denote number of times lock Lᵢ was acquired after a₀/b₀. For example, lockvector [0,1,0,2] at b₆ denotes that locks L₁ and L₃ are acquired once and twice respectively, by thread t_{b} after b₀.

Our goal is to check the pairwise reachability of (a₁₀,b₁₀), (a₁₀,b₁₁), (a₁₁,b₁₀) and (a₁₁,b₁₁) corresponding to various data races on variable X, i.e., write-read, write-write, write-read, and write-write.

Naive Algorithm:

Before we present details of our algorithm, we present a naive algorithm to check the pairwise reachability of (a₁₀,b₁₀).

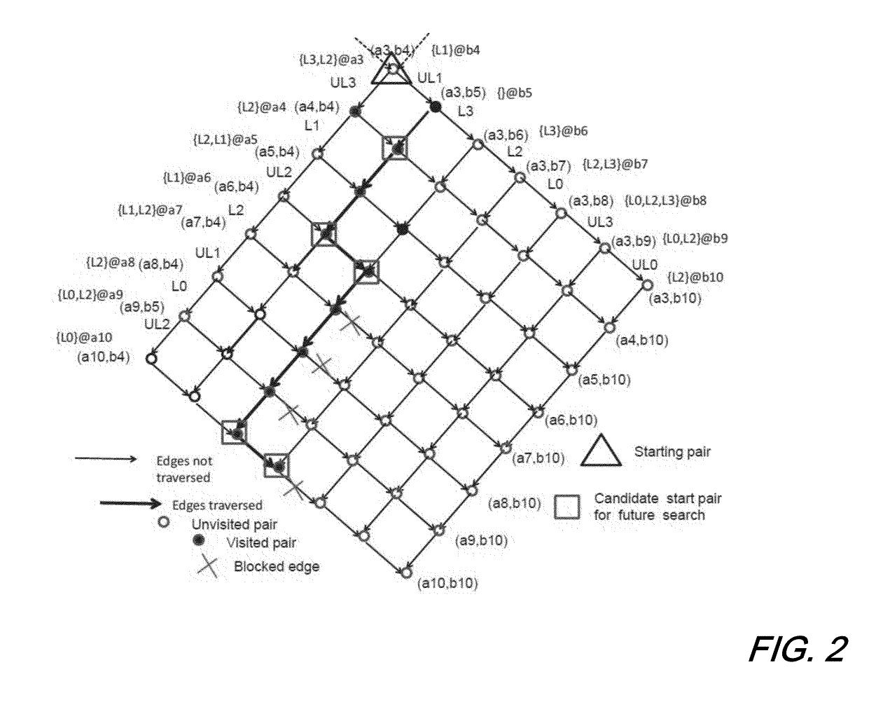

Conceptually, it involves traversing a lockset graph (LG) built using the events in the lock history of each thread, as shown in FIG. 2 for threads tₐ and t_{b}. We use Lᵢ/ULᵢ to denote the lock/unlock of the lock object Lᵢ respectively.

For now, assume (a₃,b₄) is pairwise reachable. In the discussion of our actual algorithm, we discuss how we select such a starting pair that is pairwise reachable.

We compute lockset at each thread location. A pair of events (aᵢ,bⱼ) with lockset LS(aᵢ) and LS(bⱼ) respectively, is unreachable if the locksets are not disjoint. The LG has size quadratic in the size of lock history, i.e., O(m·n) where m,n are the sizes of lock history of respective threads.

The naive algorithm solves the pairwise reachability by constructing a consistent sequence (if one exist) starting from (a₃,b₄)) to (a₁₀,b₁₀). If it finds such a sequence, it correctly infers pairwise reachability; otherwise, it correctly infers un-reachability. A simple depth-first-search strategy would require O(m·n) checks. A by-product of this simple approach is that one can also detect potential deadlock.

In the next section, we will extend and improve the basic algorithm to check pairwise reachability.

Our Approach

Our primary goal is to show that there exists some consistent sequence of the history lock events without constructing the lockset graph (LG) that has O(m·n) edges. Specifically, we take various optimization steps to achieve the same without affecting the reachability as follows:
Reduce the effective length of TLH by selecting a suitable starting pair that is reachable.
Identify and eliminate redundant and inconsistent traversal.
Add capability for incremental checks to amortize the cost for multiple checks.

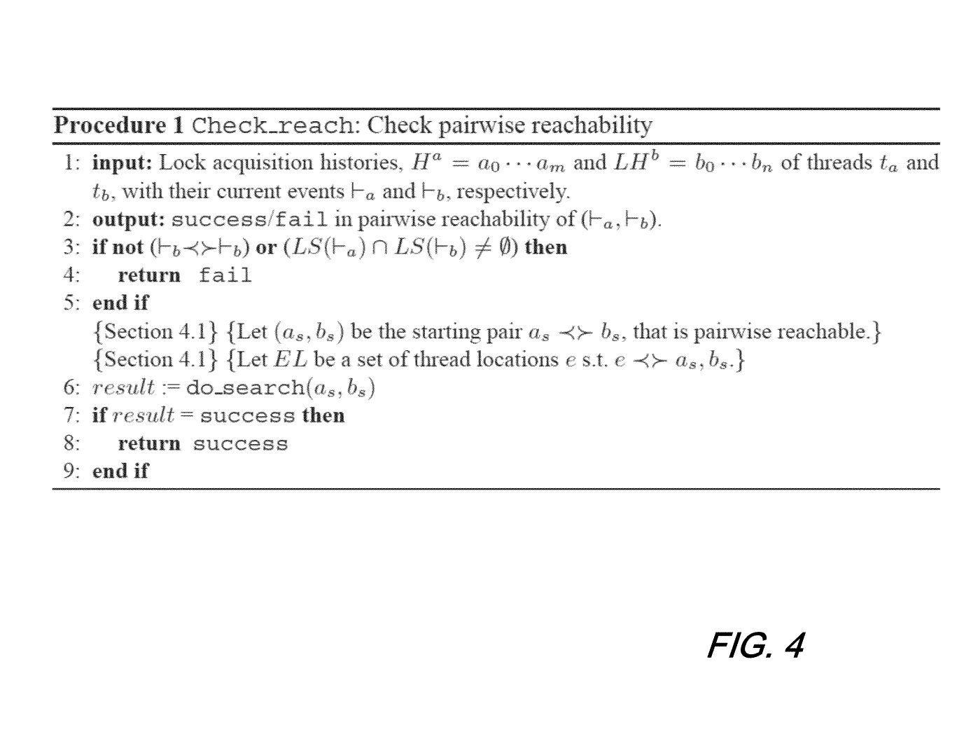

Before we delve into details, we present an overview of our algorithm Check_Reach shown as Procedure 1 in FIG. 4. With respect to that FIG, we note the following.

Basic Check.

In lines 3-5, we first check if the pair (├ₐ,├_{b}) has must-happens-before ordering or has intersecting locksets. If either holds, we return fail denoting unreachability.

Identify Starting Thread Events.

We identify a starting reachable pair (aₛ,bₛ) where a₀ [symbol] aₛ [symbol] aₘ and b₀ [symbol] bₛ [symbol] bₙ (as discussed later). Evidently, such a pair would reduce the search complexity to O(δₐ·δS_{b}) where δₐ,δ_{b} are lengths of the sequence aₛ . . . aₘ and aₛ . . . aₙ, respectively. We also identify a set of earliest lock events EL of other threads (≠tₐ,t_{b}) s.t. e [symbol] aₛ for each e∈EL. We use the set in our search to guarantee true positive for more than two threads.

Search for Reachability.

In line 6, we invoke a recursive algorithm do_search (Procedure 4) to search for a consistent sequence of the history events in H^{a},H^{b} from (a,b) to (├ₐ,├_{b}).

We have two contrasting strategies (complementary in strengths) for more than two threads, i.e., strategy-I, and strategy-II. In strategy-I, we ignore TLHs of the remaining threads (≠tₐ,t_{b}). In this strategy, if fail is returned, the pair is guaranteed unreachable; however, if success is returned, the pair may be unreachable. In strategy-II, in contrast, we consider the TLHs of remaining threads to guarantee the pairwise reachability if success is returned. However, if a fail is returned, the pair may not be unreachable.

For two threads, strategy-II is redundant. The result of strategy-I is guaranteed, i.e., a success result implies reachability and fail result implies unreachability.

The worst complexity of either strategy-I and strategy-II is O(δₐ,δ_{b}).

Starting Thread Events Pair

We use the following criteria for selecting a starting pair. Given TLHs H^{a}, H^{b}, let (a,b) denote the last unblocking/blocking matching event pair with a∈a₀ . . . a·aₛ . . . aₘ and b∈b₀ . . . b·bₛ . . . bₙ, such that there does not exist a′ [symbol] _{ub} b′ or b′ [symbol] _{ub} a′ where a′∈aₛ . . . aₘ and b′∈bₛ . . . bₙ.

If such a pair exists, we have either a [symbol] _{ub} b or b [symbol] _{ub} a but not both. We select (aₛ,bₛ) as the starting pair, where aₛ=next(a), and bₛ=next(b).

Lemma 1.

The starting pair events obtained above is pairwise reachable.

Proof.

Let a [symbol] _{ub} b be the last unblocking/blocking matching pair operations of threads tₐ,t_{b} respectively, as observed. As noted before, for correct synchronization the blocking operation has to block first for the matching unblocking event; however, unblock event completes before the block event completes. That means, (loc(a),loc(b)), i.e., (a,b) is pairwise reachable. As b gets unblocked, (next(a), next(b)) becomes pairwise reachable. When b [symbol] _{ub} a is the last unblocking/blocking matching pair, we argue similarly.

### Example

In the running example, we use the pair (a₃,b₄) as the starting pair, as the notify/wait matching event occur at locations b₃/a₂ respectively.

If such a pair does not exists, then depending on the strategy we select the following pairs.

For strategy I, we use (a₀,b₀) as the starting pair. For strategy II, we use the following method.

Let c [symbol] _{ub} d be the last observed events between some pair threads i.e., c,d [symbol] aₘ,bₙ. We create a set of earliest lock events of other threads, denoted as EL (at most one per thread) that are comparable to cₛ,dₛ where c=next(c), and dₛ=next(d)), i.e., EL={e_{c}|for a thread t_{c}∈T, if there exists an event e_{c}=next(x) where x [symbol] cₛ, and e_{c} [symbol] cₛ}. We select (a,b) as the starting pair where a,b∈EL, which is pairwise reachable.

We use the set EL in strategy-II to consider possible interference due to the other threads.

### Search for Reachability

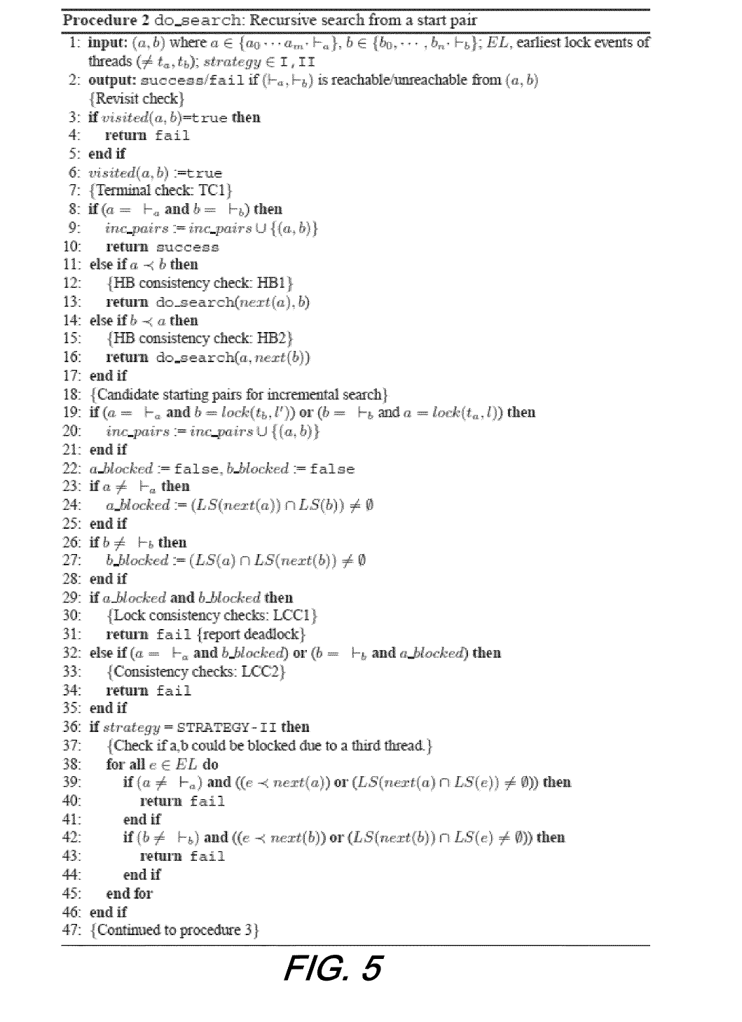

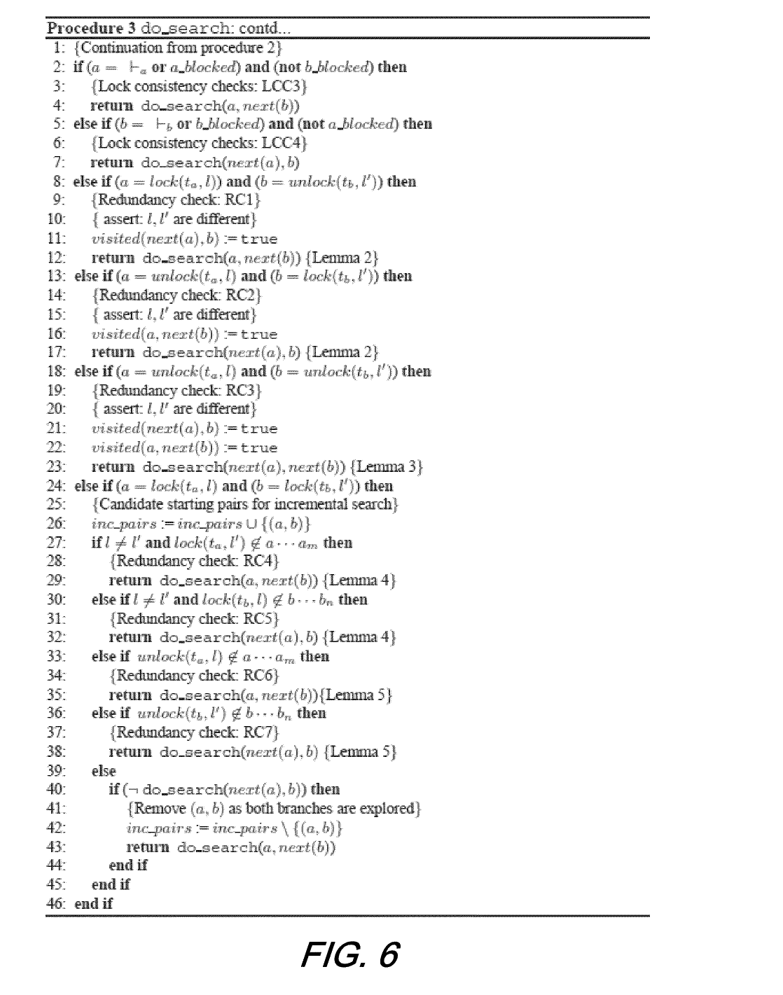

The algorithm do_search is shown as Procedure 2 (and continued in Procedure 3) which are depicted in FIG. 5 and FIG. 6, respectively. The checks TC1, HB1-HB2, and LCC1-LCC4 as indicated are various terminal, happens-before and lock consistency checks to avoid incomplete and consistent sequence. The redundancy checks RC1-RC7 are various simplification steps to eliminate the need for exploring both ordering of the events. We discuss the role of these checks in detail below.

TC1: Detect if we reached our goal pair (├ₐ,├_{b}).

HB1-HB2: Enforce a [symbol] b or b [symbol] a ordering.

LCC1: Detect a deadlock situation between the pair threads when both events are blocked due to each other's lock history.

LCC2: Detect a situation when one thread is blocked by the other, while all events in TLH of the other thread have been traversed.

STRATEGY-II. Detect if any event (a or b) is blocked by an event of third thread that must happen-before or has intersecting locksets. The check is applied for three or more threads to give a guarantee on the success (i.e., reachable) result.

LCC3-LCC4: Detect a situation when one thread event is blocked by the other, and the other thread event is not blocked by a third thread. A recursive call is made with the next event of the unblocked thread.

RC1-RC2: Detect a situation when one thread event is lock and other thread event is unlock. Note, both events are on different lock objects. A recursive call is made with the next(unlock) event. A key observation is that applying unlock before lock event does not affect the reachability (Lemma 1).

RC3: Detect a situation when both thread events are unlock. Note, both events are on different lock objects. A recursive call is made with both thread events. Key observation here is that applying both unlocks does not affect the reachability (Lemma 1).

RC4-RC5: Detect a situation when both threads events are lock on different objects, and one thread does not acquire the other lock object before the end of the history. In RC4 check, for example, we use LV(├ₐ)[l″]>LV(a)[l′] to determine if l′ is acquired after l. A recursive call is made with the next(lock) event of the other thread. Such a move won't affect the reachability as the lock of the other thread is not acquired (Lemma 1).

RC6-RC7: Detect a situation when both threads events are lock on different objects, and one thread does not release the lock object before the end of the history. A recursive call is made with the next(lock) event of the other thread. Such a move won't affect the reachabiltity, as the lock of the other is not released (Lemma 1).

For other cases, we make a recursive branch with the next(lock) event of one thread, followed by that of the other if we obtain fail in the first call. We use visited to avoid revisiting a pair during the search.

For incremental search, we also record a set of candidate start pairs inc_pairs. We discuss more of this later.

### Example

We show the run of Check_reach as shown in FIG. 2. We use to denote the visited pairs, and ∘ to denote the unvisited pairs, and Δ to denote the starting pair(s). We use thick and thin arrow to show the visited/unvisited edges. We also show the locksets at each thread location. In Table 0, we show the checks responsible for detecting situation where we avoid exploring one (out of two) ordering of the events. For now, ignore the Column with inc_pairs. In LG graph, there are a total of 97 edges, but the procedure makes only 13 recursive calls to show the unreachability of a₁₀,b₁₀

Lemma 2.

If a sequence σ=lock(tₐ,l) . . . e . . . e′·unlock(t_{b},l′) is consistent, where each event between lock and unlock is from thread tₐ, then the sequence σ′=unlock(t_{b},l′)·lock(tₐ,l) . . . e . . . e′ . . . is also consistent.

Lemma 3.

If a sequence σ=unlock(tₐ,l)·e . . . e′·unlock(t_{b},l′) . . . is consistent, where each event between the unlock is from thread tₐ, then the sequence σ′=unlock(t_{b},l′)·unlock(tₐ,l)·e . . . e′ . . . is also consistent.

Lemma 4.

If a sequence σ=lock(tₐ,l)·e . . . e′·lock(t_{b},l′) . . . is consistent, where each event between the lock is from thread tₐ, and lock(tₐ,l′)∉σ, then the sequence σ′=lock(t_{b},l′)·lock(tₐ,l)·e . . . e′ . . . is also consistent.

Lemma 5.

If a sequence σ=lock(tₐ,l)·e . . . e′·lock(t_{b},l′) is consistent, where each event between the lock is from thread tₐ, and unlock(tₐ,l)∉σ, then the sequence σ′=lock(t_{b},l′)·lock(tₐ,l)·e . . . e′ . . . is also consistent.

Theorem 1.

For a given time stamped lock histories of two-threaded program, the procedure for checking pairwise reachability Check_reach guarantees true positive and true negative under data abstraction.

Proof.

The starting pair selected is pairwise reachable as per Lemma 4.1. RC1-RC7 checks avoid recursive calls on both branches. Using Lemmas 1-1, we show that the recursive calls made on only one branch (in RC1-RC7 checks) do not affect the reachability. Other checks such as HB1-HB2 and LCC1-LCC4 avoid inconsistent sequence. Thus, if there exists a consistent sequence, the procedure returns success; otherwise, it returns fail. The claim follows.

Theorem 2.

For a given time stamped lock histories of three or more threaded program, the procedure for checking pairwise reachability Check_reach guarantees true negative under data abstraction using strategy-I.

Proof.

In this strategy, we ignore the locks held by other threads but maintain the causal order of unblocking/blocking events between the threads. If a pair is found unreachable, the pair is indeed unreachable as holding a lock by another thread will not affect the unreachability result.

Theorem 3.

For a given time stamped lock histories of three or more threaded program, the procedure for checking pairwise reachability Check_reach guarantees true positive under data abstraction using strategy-II.

Proof.

As discussed later, the starting pair (aₛ,bₛ) can correspond to either last unblocking/blocking event between these two threads or between some pair threads. In both cases, they are reachable, former by Lemma 1, the latter by construction. Assume the procedure returns success. Then, for each (a,b) s.t aₛ . . . a . . . aₘ, and bₛ . . . b . . . bₙ, and each e∈EL, we have e [symbol] a and e [symbol] b, LS(e)∩LS(a)=Ø and LS(e)∩LS(b)=Ø. Clearly, the corresponding sequence is consistent as each e∈EL does not interfere with the sequence.

Search Complexity.

We describe the cost of each check in the procedure do_search.
Cost of each HB check is O(|T|), |T| is the number of thread.
Cost of each LCC check is O(|L|), |L| is the number of lock.
Cost of strategy-II checks is O(|L∥T|).
Cost of RC1-RC7 is O(1).

Thus, each call of do_search costs O(|L∥T|). The locksets and lockvectors for each history event can be computed in O(m+n). The number of recursive calls depends on the number of branches made. For b number of branches, the search complexity is O(b·(m+n)). In practice b<<(m+n), and the procedure runs almost in linear time. In the following, we reduce the amortized cost of multiple pairwise reachability checks.

Incremental Search

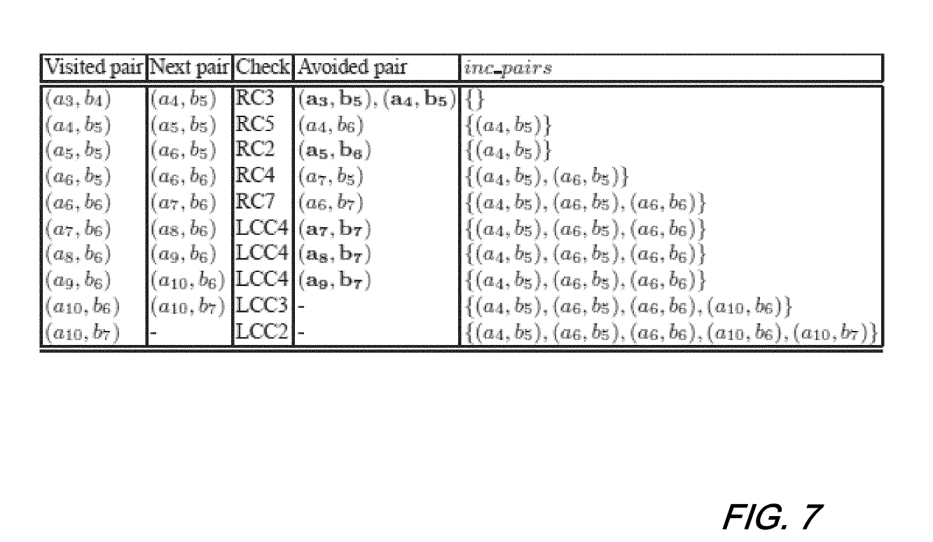

The procedure do_search can be used incrementally for checking multiple pairwise reachability problems that arise during online race detection, especially, when the pairs under considerations have overlapping histories. In the following, we discuss one such way that uses the visited state information and inc_pairs set of pairs gathered during the previous run of Check_reach. The inc_pairs is a set of reachable pairs which were not required to be explored further for the previous search, but might be required now due to new events in the history. As shown in Table 1—FIG. 7, the avoided pairs (not shown in bold) may need to be re-evaluated, and therefore, we update the inc_pairs accordingly in RC5, RC4, RC7, LCC3, and LCC2 checks. Note, those avoided pairs shown in bold are truly redundant, and is not required to be explored in incremental search.

Assume, we have used the procedure to search for a consistent sequence with given TLHs H^{a},H^{b} where H^{a}=a₀ . . . aₘ and H^{b}=b₀ . . . bₙ, starting from the pair (aₛ,bₛ). Let NH^{a},NH^{b} denote the new TLHs histories where NH^{a}=H^{a}·aₘ₊₁ . . . a_{m′}, and NH^{b}=H^{b}·bₙ₊₁ . . . b_{n′}. Assume the pair (aₘ₊₁,bₘ₊₁) was not pairwise reachable in our previous search. Also, assume the previous starting pair (aₛ,bₛ) is the starting pair for the new history NH^{a},NH^{b}. Under these scenarios, we start the procedure do_search only from the pairs in the set inc_pairs, and use the visited state information to avoid exploring the already visited pairs. As each pair in inc_pairs is reachable from (aₛ,bₛ), pairwise reachability from such a pair implies pairwise reachability from (aₛ,bₛ).

The main observation is that only the pairs in the set inc_pairs are required to be re-checked, as the redundancy conditions (RC4-RC7) and terminal conditions might have changed due to the new history events.

If (aₘ₊₁,bₘ₊₁) is pairwise reachable, we also use that as the starting pair. If there exists a matching unblocking/blocking events (a,b) that happens after (aₘ₊₁,bₘ₊₁), i.e., a [symbol] _{ub} b or (b [symbol] _{ub} a) such that aₘ₊₁ [symbol] ₚₒ a and bₙ₊₁ [symbol] b, we use (next(a),next(b)) as the starting pair as discussed herein.

### Example

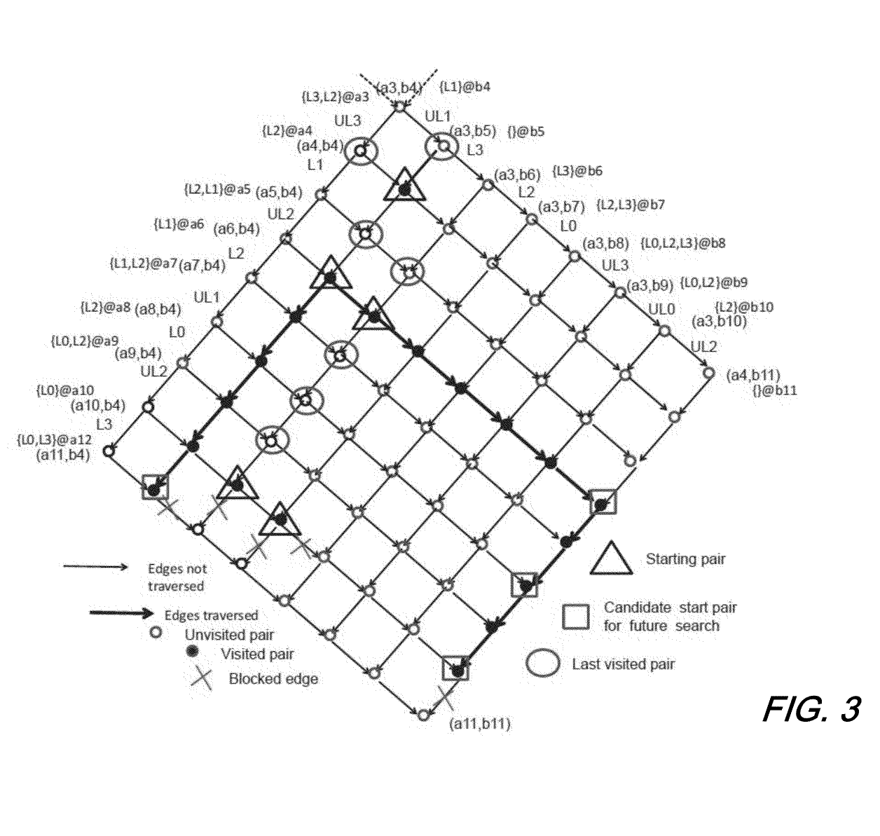

We show how we incrementally check the reachability of pairs (a₁₀,b₁₁), (a₁₁,b₁₀), and (a₁₁,b₁₁), as shown in the FIG. 3. We start with the pairs in the set inc_pairs as shown in Δ. We avoid the nodes that are already visited (shown with oval circle). We explore the alternate paths (i.e, sequence of lock/unlock events of one or more threads) from the pair (a₆,b₅) as RC4 check fails due to the new event lock(tₐ,L₃) at a₁₀. Similarly, we explore the alternate path from the pair (a₆,b₆). The newly explored edges and nodes are indicated in the figure. We find that the pairs (a₁₀,b₆),(a₁₀,b₇) are deadlock states. Further, we find that the pair (a₁₀,b₁₁) is pairwise reachable (indicating write-write race), and the rest pairs are not.

### EXPERIMENTAL

We implemented our approach as a COP (Causal Online Predictor) module in BEST tool framework. BEST is a x86 binary-based concurrency testing framework. The tool has a built-in offline symbolic analysis module to predict concurrency errors.

We use gcc/g++/gcj compilers to transform C/C++/Java programs to x86 binaries. At runtime, the application binary and dynamically loadable libraries such as pthread are instrumented using PIN to record the synchronization events such as wait/notify, lock/unlock, create/start, end/join, sem_wait/sem_post, and heap memory accesses. We experimented on a 32-bit linux workstation with a Intel® Core™2 Quad CPU Q6600 2.4 GHz with 4 GB memory.

Benchmarks.

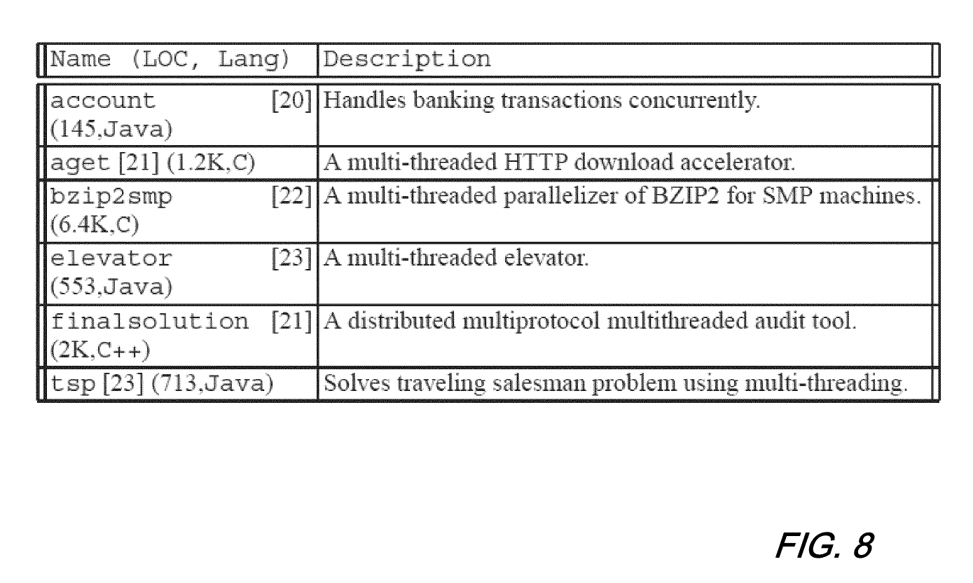

We used 6 multi-threaded publicly available applications (written in C/C++/Java) with 1K-6K LOC. Table 2—FIG. 8 gives a short description of these applications.

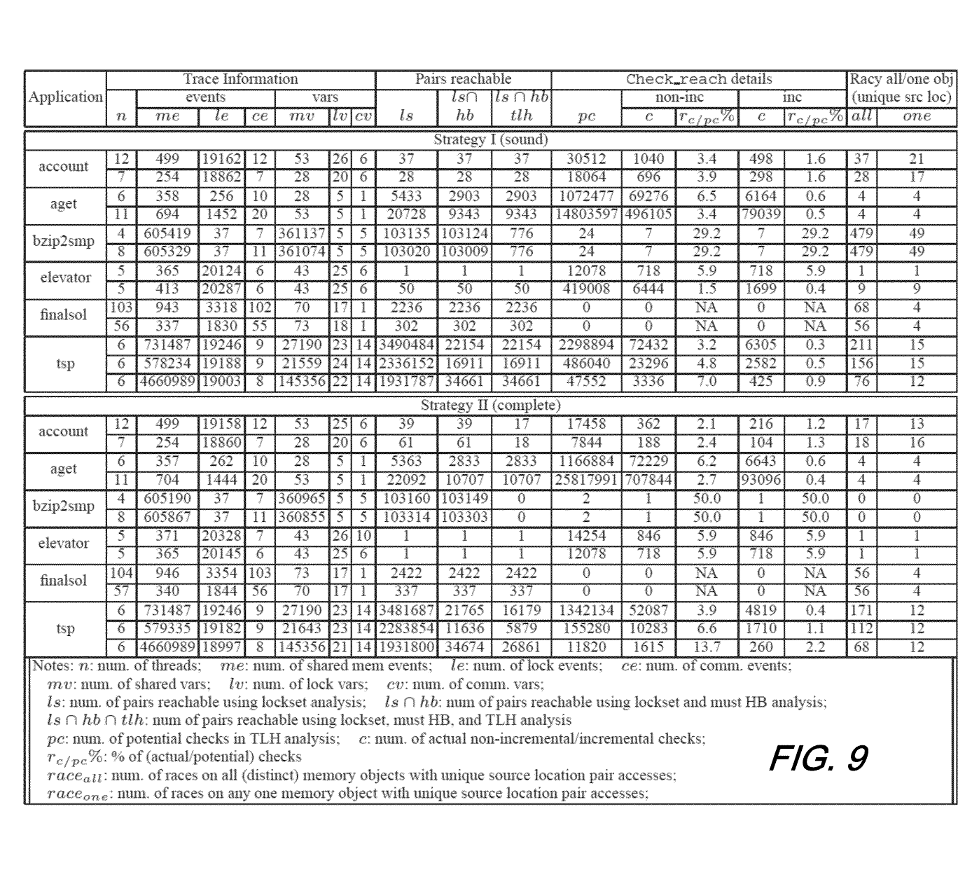

Results of Pairwise Reachability (Reported in Table 3—FIG. 9)

We ran each application with different thread settings and/or program test input. For fair comparison, we evaluated both incremental and non-incremental implementation of Check_reach procedure in the same run for a given strategy (I or II).

Trace Information.

The trace information corresponding to each run are shown in Columns 2-8 respectively as follows: the number of threads n, the number of shared memory events me, the number of lock events le, the number of communication events (blocking/unblocking) ce, the number of shared vars mv, the number of lock vars lv, and the number of communication vars cv.

Pairs Reachable.

The number of reachable pairs corresponding to race conditions as found by following analysis are shown in Columns 9-11 respectively: using lockset analysis alone ls, using lockset and must HB analysis ls∩hb, and using lockset, must HB, and TLH analysis ls∩hb∩tlh.

Check_Reach Details.

In Columns 12-16, we compare non-incremental and incremental TLH analysis respectively as follows: the number of potential checks pc, the number of actual checks (non-incremental) c, the ratio (in %) of actual (non-incremental) to potential checks r_{c/pc} %, the number of actual checks (incremental) c, and the ratio (in %) of actual (incremental) to potential checks r_{c/pc} %.

Races.

We project reachable pairs (corresponding to different threads and multiple execution of source lines) to pairs of source locations. We present the number of races on all (distinct) memory objects with unique source location pair accesses in Column 17. In Column 18, we present the number of races on any one memory object with unique source location pair accesses.

Discussion.

Using TLH analysis, one can reduce the pairwise reachable pairs significantly as shown for the example bzip2smp. We observe the number of actual checks is a small fraction of the potential checks. Furthermore, the incremental checks reduce overhead further by an order of magnitude in some cases, thereby amortizing the cost.

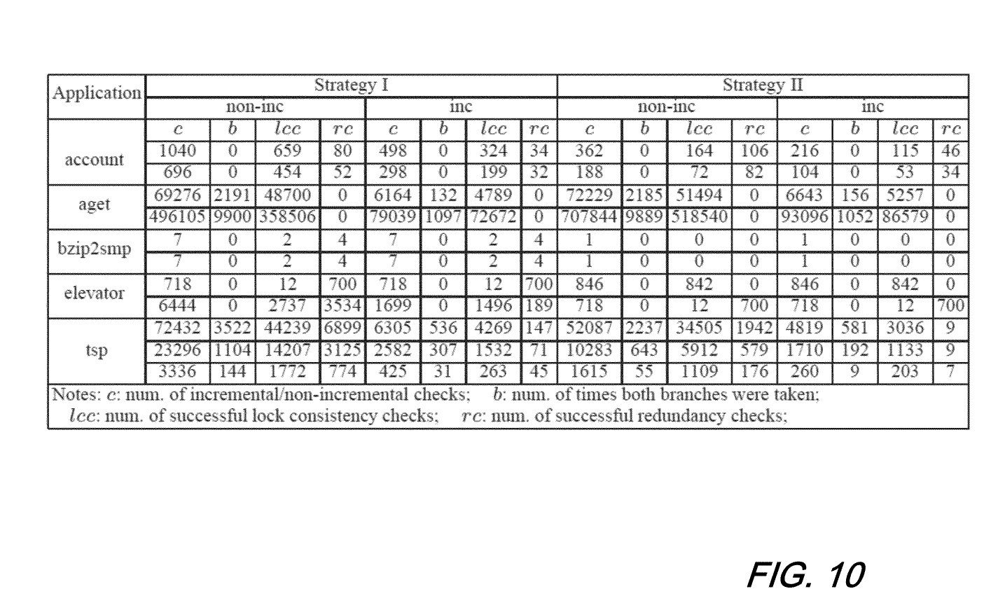

Results of Analysis of Check_Reach (Reported in Table 4—FIG. 10)

We present the details of actual checks (non-incremental and incremental) for strategy I and strategy II in Columns 2-9, and Columns 10-17 respectively. Columns 2-4 are as follows: the number of non-incremental actual checks c (as in Column 13, Table 3—FIG. 9), the number of times both branches were taken b, the number of successful lock consistency checks lcc, and the number of successful redundancy checks rc. The other columns are similarly described. Advantageously, we observe that in the most cases, the procedure avoids taking both the branches due to redundant and lock consistency checks.

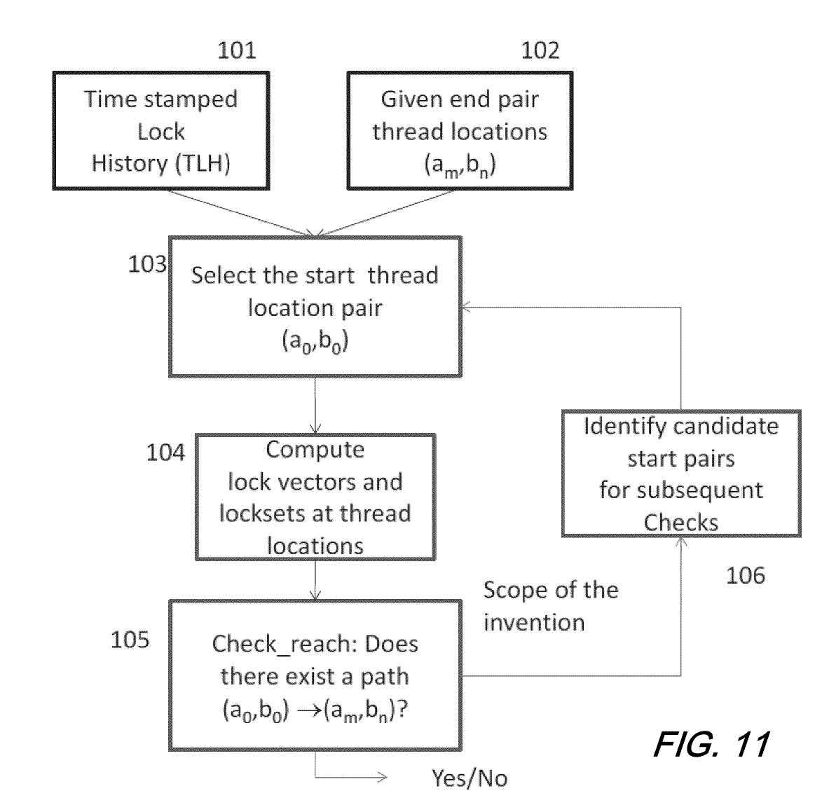

Turning now to FIG. 11, there is shown a flow diagram depicting the steps associated with a pairwise reachability determination according to an aspect of the present disclosure. With reference to that FIG. 11, it may be observed that the determination proceeds according to the following.

At Block 101 and Block 102, we are given a lock acquisition history of two threads namely, ‘a’ and ‘b’ at Block 101, and a goal reachable pair (aₘ,bₙ) at Block 102.

At Block 103, we first identify the starting pair (a₀,b₀) such that a₀=next(x), and b₀=next(y) and x/y are the latest matching unblocking/blocking event, and next(x) is the next thread order event of x.

At Block 104, we construct lock vectors and locksets at each location in a₀, . . . , aₘ and b₀ . . . , bₙ by executing the corresponding lock events.

At Block 105, We find a path from (a₀,b₀) to (aₘ,bₙ) using the following check_reach algorithm, namely, check_reach((a₀,b₀)(aₘ,bₙ)).

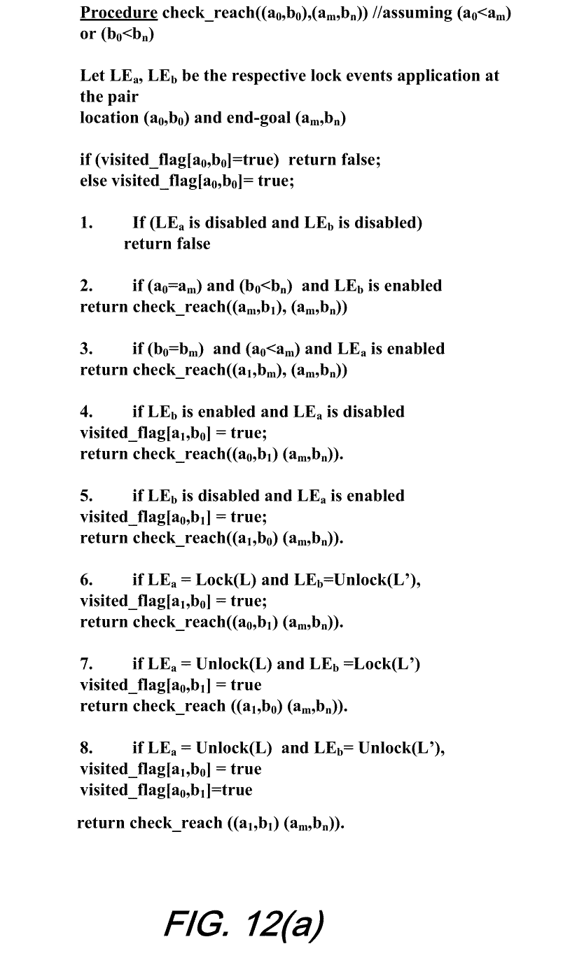

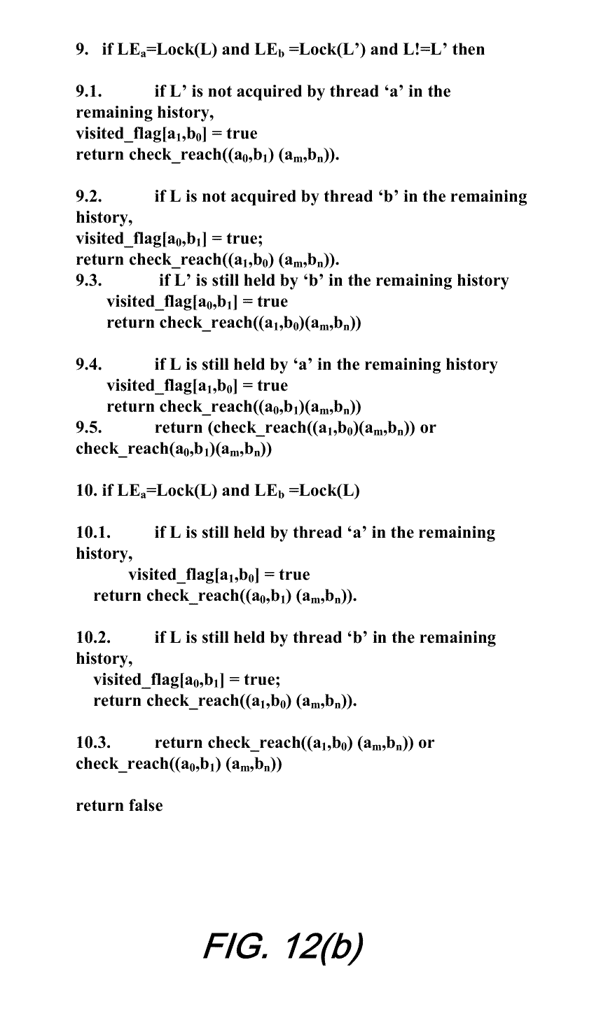

The procedure check_reach is shown in FIGS. 12(a) and 12(b) where cases 1-6 are disjoint. With simultaneous reference to FIGS. 12(a) and 12(b), it is noted that steps 1 thru 10 are various simplification steps (illustrated in FIG. 11) to eliminate the need for branching. Step 9.3/10.3 involve branching when the order of two lock acquires needed to be handled. We use a DFS based strategy to prevent repeat traversal from the node (a₀,b₀). Note that LEₐ (LE_{b}) is enabled at (a₀,b₀) if locksets at a₁ (a₀) and b₀ (b₁) are disjoint.

Finally, at Block 106, If (aₘ,bₙ) is reachable, we use that as the starting pairs for subsequent checks. Otherwise, we select pairs that were not explored in steps 2,3, 9.1-9.4, and 10.1-10.2, and visited flags to avoid repeat exploring same pairs.

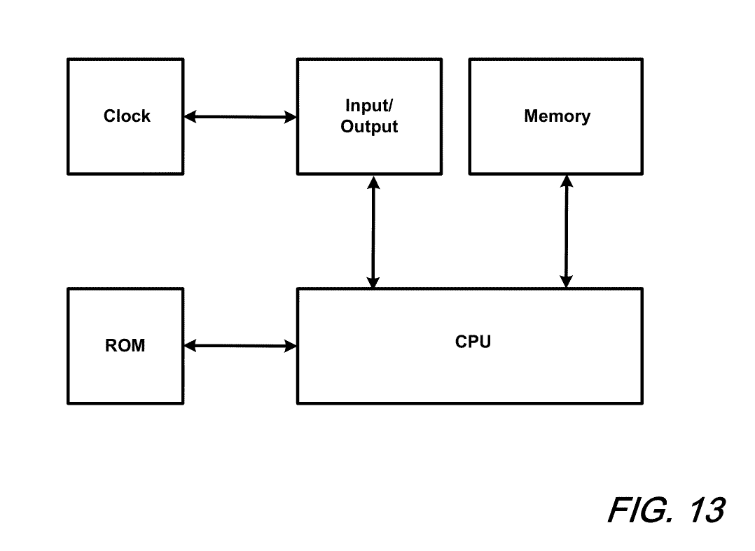

As those skilled in the art will readily appreciate, such method(s) according to the present disclosure may be implemented and executed on any of a number of contemporary computer systems such as that depicted in FIG. 13. Operationally, and when programmed to do so, the computer will utilize lock acquisition history of pair threads, pair-wise thread locations and perform the reachability check to determine whether the pairwise reachability is achievable. An indica of the determination may be output to a user or another computer/program for subsequent use.

At this point it is noted that a simple but yet effective strategy to check pairwise reachability in an online analysis under a general locking scheme where locks may be acquired in recursive, non-nested, or nested manner has been shown and described. Under data abstraction, such an approach guarantees true positives and negatives for two-threaded system. For more than two threaded, it guarantees either true positive or true negative (but not both). It uses time stamped lock/unlock events to identify and avoid redundant and inconsistent sequence. Importantly, the approach is incremental and reduce amortized cost of checking multiple pairwise reachability problems. The worst case complexity is quadratic in the length of the history; in practice, however, the running cost is linear in the length of the history. Such an approach improves the accuracy of the race prediction for general locking style that includes recursive, nesting/non-nesting, and thereby improving the overall runtime verification.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. A computer-implemented method of checking pairwise reachability of locations in concurrent threads from a history of lock acquire and release events said method comprising the steps of:
determining lock vectors and locksets at a history of each thread location
determining whether a path, comprising of a sequence of lock and unlock events of one or more threads, from a starting pair location to a destination pair location exists such that events in the path respect must-happen-before ordering and synchronization semantics, and outputting the path if it exists and exploring all such paths, and outputting void if no such path exists while identifying and eliminating any inconsistent and redundant path(s);
and constructing such a path on-the-fly during exploration without preconstructing the entire graph
wherein the locks may be acquired and released in a recursive, nested or non-nested manner.

2. The method of claim 1 wherein said starting pair in the history is selected according to latest matching unblocking and blocking events between the pair thread.

3. The method of claim 1 wherein the said starting pair in the history is selected such that the starting pair event of one thread does not must-happen before the starting event pair of the other thread.

4. The method of claim 1 wherein a subset of pairs that were not explored are used as candidate start pairs for incrementally checking subsequent pairwise reachability of destination pairs with overlapping histories with previously explored destination pairs.

5. The method of claim 1 wherein the path is determined during the execution of the concurrent program.

6. The method of claim 1 wherein the path is determined during post execution of the concurrent programs.

7. A computer-implemented method of checking pairwise reachability of locations in concurrent threads from lock acquire and release events history wherein the locks may be acquired in a recursive, nested or non-nested manner, said method comprising the steps of:
receiving a lock acquisition history of two threads namely, ‘a’ and ‘b’ and a goal reachable pair (aₘ,bₙ);
identifying a starting pair (a₀,b₀) such that a₀=next(x), and b₀=next(y) wherein x/y are the latest matching unblocking/blocking synchronization event between the pair threads, and next(x) is the next thread order event of x;
construct lock vectors and locksets at each location in a₀, . . . , aₘ and b₀ . . . , bₙ by simulating corresponding lock events;
determining a path from (a₀,b₀) to (aₘ,bₙ) using a check_reach algorithm exists, namely, check_reach((a₀,b₀)(aₘ,bₙ));
determining that if (aₘ,bₙ) is reachable, then (aₘ,bₙ) is used as a starting pair for subsequent checks, otherwise, we select pairs that were not explored; and
outputting the result of reachability for (aₘ,bₙ) comprising the path if exists, otherwise void if not.
